(19) United States
(12) Patent Application Publication
(10) Pub. No.: US 2018/0214906 A1
(43) Pub. Date: Aug. 2, 2018

(54) CAULK WARMING APPARATUS

(71) Applicant: Tommy J. Gonzalez, Oak Forest, IL (US)

(72) Inventor: Tommy J. Gonzalez, Oak Forest, IL (US)

(21) Appl. No.: 15/419,378

(22) Filed: Jan. 30, 2017

(51) Int. Cl. B05C 17/005; B25H 3/06

(52) U.S. Cl. CPC B05C 17/00546; B25H 3/06

(57) ABSTRACT

Described herein is a caulk warming apparatus. The apparatus includes a body portion defining an interior cavity for the placement of caulk tubes. A lid is retained on the body portion and includes a housing containing a heating element for distributing heat throughout the body portion. The interior cavity includes a rack to retain the stored and heated tubes of caulk in a vertical position.

### CROSS REFERENCE TO RELATED APPLICATIONS

Not Applicable

### FEDERALLY SPONSORED RESEARCH OR DEVELOPMENT

Not Applicable

### SEQUENCE LISTING, A TABLE, OR A COMPUTER PROGRAM

Not Applicable

### FIELD OF THE INVENTION

The invention relates generally to a device for keeping caulk warm prior to use.

### BACKGROUND

Standard outdoor construction tasks, such as, roofing, remolding, and door and window installation require caulk to appropriately seal seams, gaps, and cracks. To be effective in sealing these seams, gaps, and cracks, this caulk must be applied in a pliable form. Most manufacturers recommend a caulk application and storage temperature range of between 40° F. and 80° F. Typically, and despite these preferred operating ranges, caulk is still applied in colder temperatures as these tasks continued to be performed in these colder temperatures. Current solutions to keeping caulk warm require the caulk to be stored within an interior structure or within a heated vehicle until the caulk is needed. This is not a desirable solution, as it requires an idling vehicle and access to an interior structure. Other solutions attempt to keep the caulk covered within an insulated blanket, but this solution is similarly unable to meet the needs of the market because not all of the caulk may remain pliable. Therefore, there is a need within the market for a caulk warming solution that is durable, easily transported to a job site, and heated through connection to a standard electrical outlet.

### SUMMARY OF THE INVENTION

It would be advantageous to have an apparatus that is affordable, durable and keeps caulk and sealants at the proper temperature for use in cold weather conditions. Furthermore, it would also be advantageous to have an apparatus that can store the caulk when not in use. Still further, it would be advantageous to have an apparatus that also has additional functionality for use as a drier of wet work wear items and clothing, such as gloves.

The invention is directed to a bucket-like apparatus for keeping caulk in a pliable, working condition in cold conditions by creating a heated storage environment for the placement of caulk and additional items.

The apparatus includes a warmed bulk storage space that is maintained at a temperature primarily designed to keep caulk and sealants pliable and stored at the desired application temperature for use in cold temperatures.

The apparatus may include temperature controls and sensors to help maintain the temperature and efficiency of the device and to ensure an adequate internal temperature to keep stored caulk and sealants at the optimal temperature.

The device interior includes storage features to receive various sizes of caulk and sealants and is adapted to provide for the storage of caulk and sealant tubes in a vertical position to maximize efficiency in both temperature and storage amount. The device interior allows for receipt of removable racks to allow for the storage and configuration of multiple sizes, dimensions, and amounts of these tubes. The interior cavity further includes a tray device to allow for the placement of additional items and materials to keep these materials warm and dry. In particular, this tray is adapted for the placement and drying of work gloves.

The heating components of the device include a fan member to provide for convection heating and air movement within the internal cavity of the device and utilize an insulated surfaces and materials to help in maintaining the internal temperature. The heating element utilizes a fan to move exterior air past a heating element and into the device interior. The heated air moves through a central chamber of the device where it is distributed across the interior. The central chamber is generally cylindrical and extends a length from a top of the cavity to the bottom of the cavity and having a plurality of apertures along this length to provide an even distribution of heated air.

The lid of the device is received on the top side of the bulk storage container and secured to a handle of the device. The handle is comprised of a generally flexible and pliable material, such as a braided cable, and is movably secured to the storage container, wherein the lid is maintained in a position on or adjacent to the storage container at all times. Accordingly, the handle retains the lid in communication with the storage container when it is open and closed. The lid further includes an integrated cord maintenance system, wherein the lid includes tabs to receive and retain a wrapped cord.

The apparatus fulfills the need for keeping caulk and sealants at the right temperature and in proper working condition to allow for application in all weather conditions.

The invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRIPTION OF THE DRAWINGS

FIG. 1 shows an isometric view of the caulk warming apparatus, according to the present invention;

FIG. 2 shows a right side view of the caulk warming apparatus, according to the present invention;

FIG. 3 shows a left side view of the caulk warming apparatus, according to the present invention;

FIG. 4 shows a front view of the caulk warming apparatus, according to the present invention;

FIG. 5 shows a rear view of the caulk warming apparatus, according to the present invention;

FIG. 6 shows a bottom view of the caulk warming apparatus, according to the present invention; and

FIG. 7 shows a cross sectional view of the caulk warming apparatus, according to the present invention.

### DETAILED DESCRIPTION OF THE INVENTION

The following detailed description includes references to the accompanying drawings, which form a part of the detailed description. The drawings show, by way of illustration, specific embodiments in which the invention may be practiced. These embodiments, which are also referred to herein as “examples,” are described in enough detail to enable those skilled in the art to practice the invention. The embodiments may be combined, other embodiments may be utilized, or structural, and logical changes may be made without departing from the scope of the present invention. The following detailed description is, therefore, not to be taken in a limiting sense.

Before the present invention is described in such detail, however, it is to be understood that this invention is not limited to particular variations set forth and may, of course, vary. Various changes may be made to the invention described and equivalents may be substituted without departing from the true spirit and scope of the invention. In addition, many modifications may be made to adapt a particular situation, material, composition of matter, process, process act(s) or step(s), to the objective(s), spirit or scope of the present invention. All such modifications are intended to be within the scope of the disclosure made herein.

Unless otherwise indicated, the words and phrases presented in this document have their ordinary meanings to one of skill in the art. Such ordinary meanings can be obtained by reference to their use in the art and by reference to general and scientific dictionaries.

References in the specification to “one embodiment” indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The following explanations of certain terms are meant to be illustrative rather than exhaustive. These terms have their ordinary meanings given by usage in the art and in addition include the following explanations.

As used herein, the term “and/or” refers to any one of the items, any combination of the items, or all of the items with which this term is associated.

As used herein, the singular forms “a,” “an,” and “the” include plural reference unless the context clearly dictates otherwise.

As used herein, the terms “include,” “for example,” “such as,” and the like are used illustratively and are not intended to limit the present invention.

As used herein, the terms “preferred” and “preferably” refer to embodiments of the invention that may afford certain benefits, under certain circumstances. However, other embodiments may also be preferred, under the same or other circumstances.

Furthermore, the recitation of one or more preferred embodiments does not imply that other embodiments are not useful, and is not intended to exclude other embodiments from the scope of the invention.

As used herein, the terms “front,” “back,” “rear,” “upper,” “lower,” “right,” and “left” in this description are merely used to identify the various elements as they are oriented in the FIGS, with “front,” “back,” and “rear” being relative to the apparatus.

These terms are not meant to limit the elements that they describe, as the various elements may be oriented differently in various applications.

As used herein, the term “coupled” means the joining of two members directly or indirectly to one another. Such joining may be stationary in nature or movable in nature and/or such joining may allow for the flow of fluids, electricity, electrical signals, or other types of signals or communication between two members. Such joining may be achieved with the two members or the two members and any additional intermediate members being integrally formed as a single unitary body with one another or with the two members or the two members and any additional intermediate members being attached to one another. Such joining may be permanent in nature or alternatively may be removable or releasable in nature.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the disclosure.

The invention is directed to be a caulk warming apparatus.

The invention is generally a storage container, similar to a bucket, which stores up to a dozen caulk tubes in a warm environment. The apparatus utilizes heated air and insulating materials to keep the enclosed caulk and sealant tubes warm and pliable for use in cold environments. Temperature sensors sustain caulk fluidity and help to control the overall power consumption of the apparatus. The device is powered though electricity and utilizes a power cord. The device is easily transported between job sites and includes features to increase this portability, such as retaining features for the cord and a handle for the device.

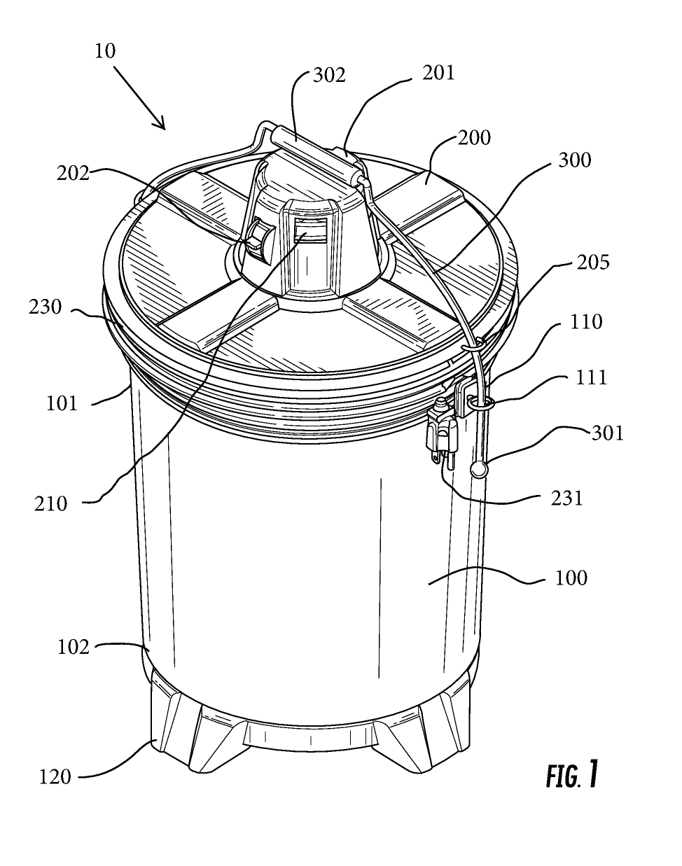

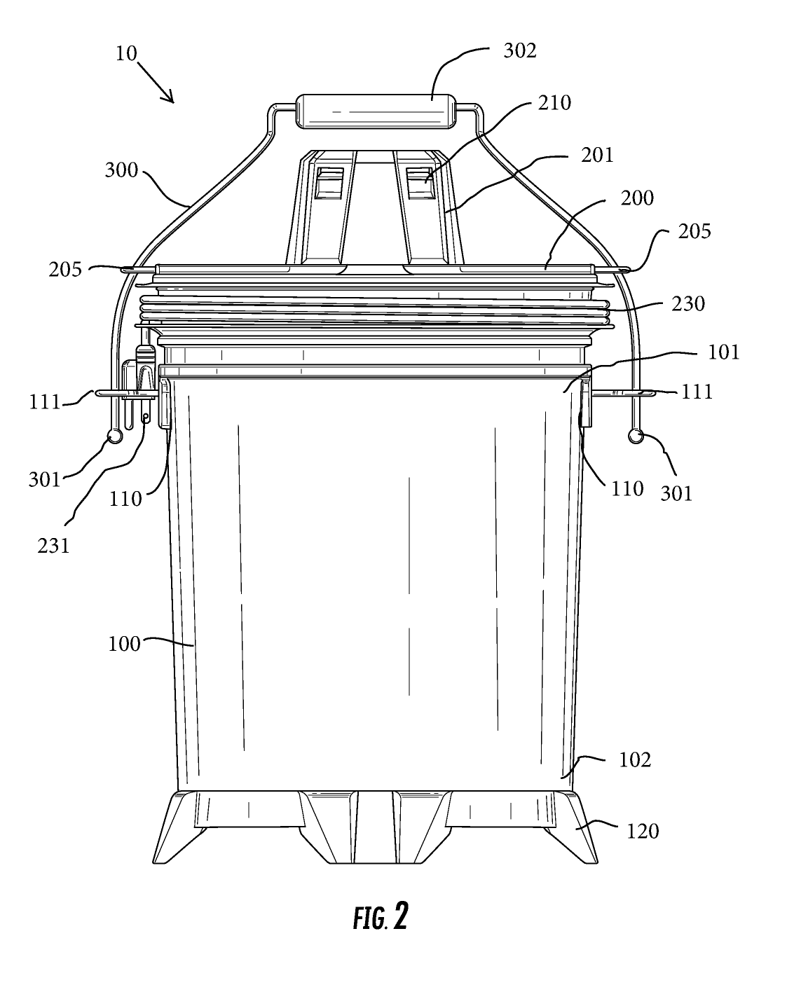

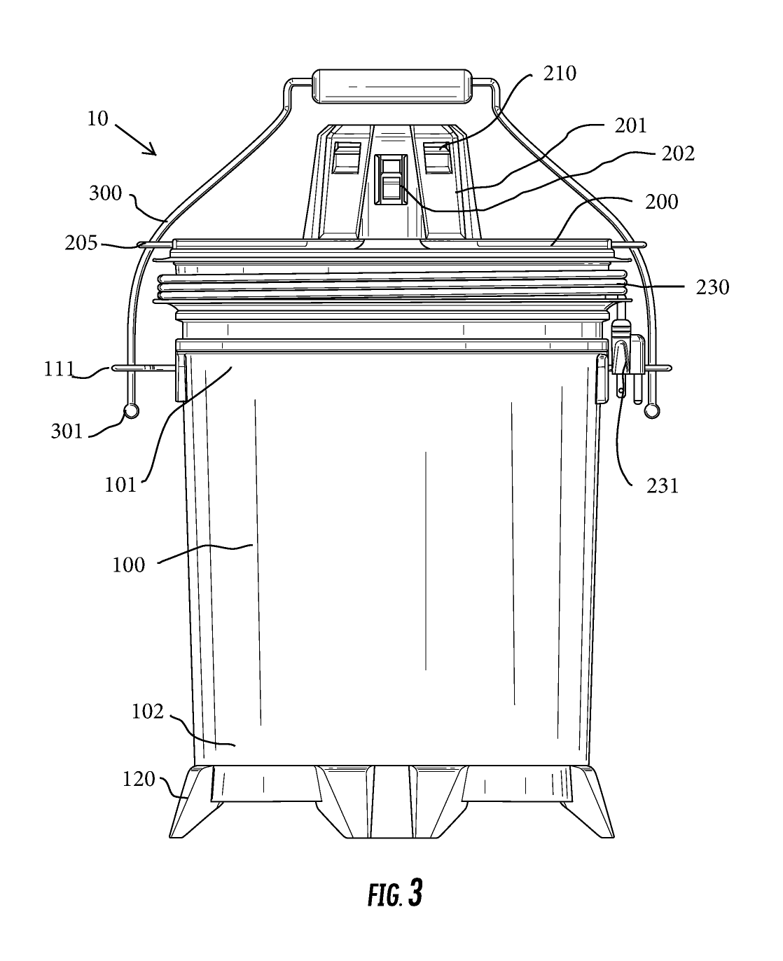

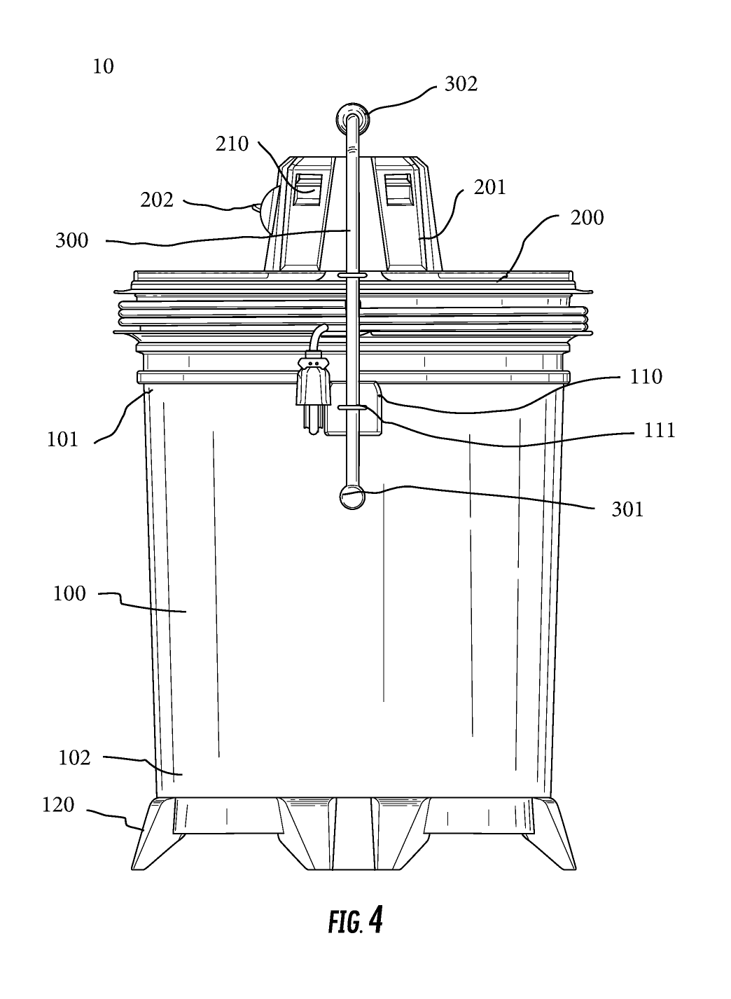

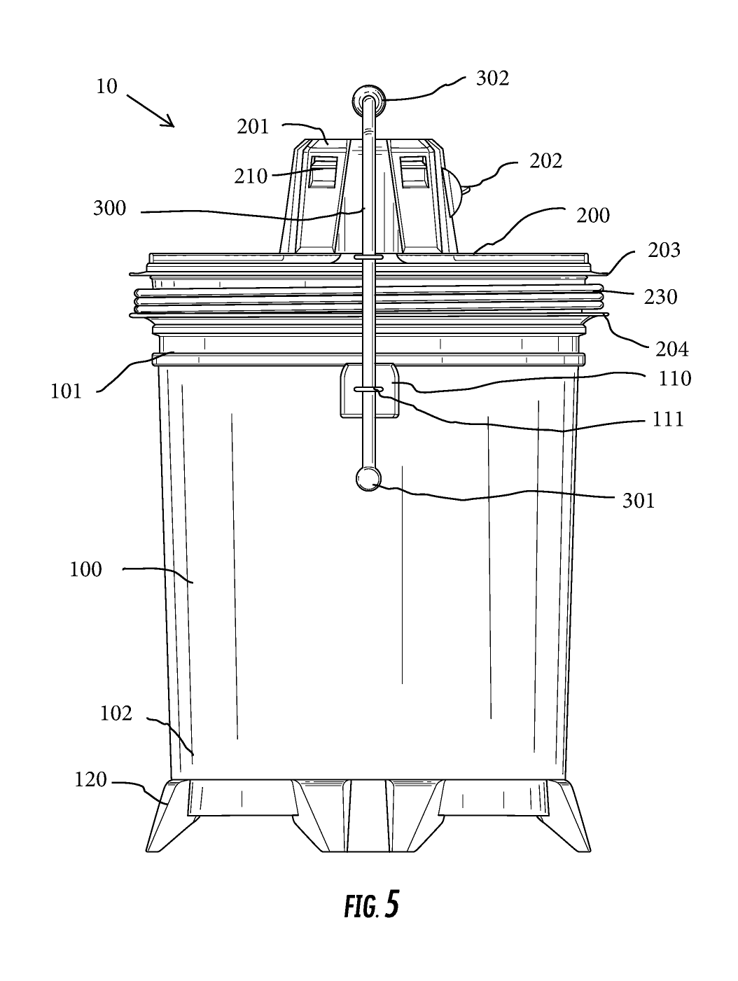

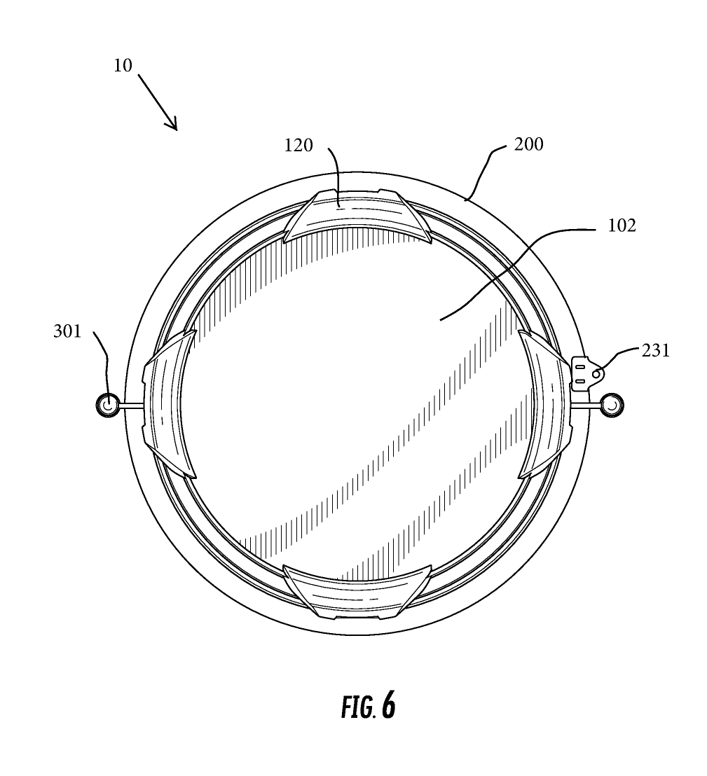

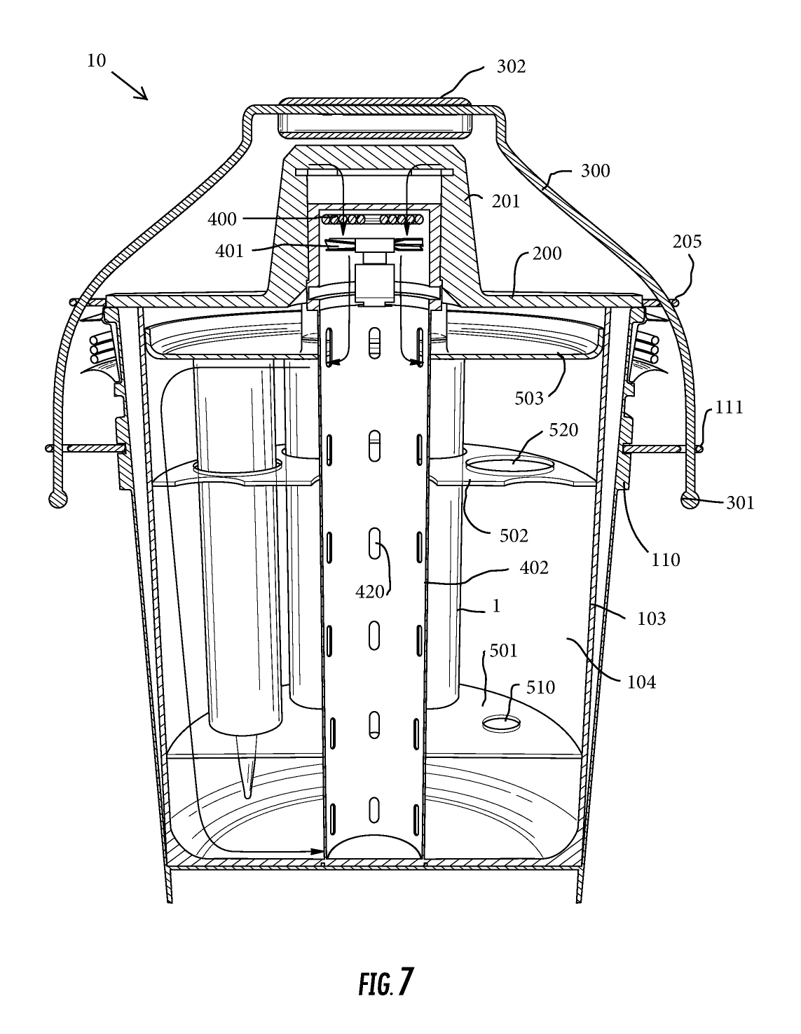

Referring to the figures, FIGS. 1-7 show the caulk warming device, according to the present invention and generally referred to as device 10. The device 10 is comprised of a body portion 100, lid 200, handle 300, heating element 400, and storage rack 500. The body portion 100 is generally cylindrical with a sidewall defining an interior cavity 104 and having a top side 101 and bottom side 102. The top side 101 defines an opening of the body portion 100 and is in communication with the bucket interior cavity 104. The bottom side 102 is positioned at a bottom of the body portion 100 and defines the enclosed end of the body portion 100. A plurality of feet 120 are affixed to the exterior of the bottom side 102 and support the body portion 100 raising the device 10 off of the surface it is placed upon.

The interior surface 103 of the body portion is comprised of an insulating material and positioned between the interior cavity 104 and body portion 100 exterior. This insulating material 103 acts as a temperature barrier to ensure that the interior cavity 104 can maintain a temperature.

The exterior of the body portion 100 includes a pair of handle brackets 110 and a pair of retaining rings 111 positioned adjacent to the top side 101 on opposed sides of the body portion 100. Each handle bracket 110 and each retaining ring 111 secure an end of the handle 300. Each end of the handle 300 includes a tab 301. The tab 301 is sized larger than the retaining ring 111, wherein the handle 300 cannot be removed from the body portion 100. The handle 300 is comprised of a pliable material and flexible to allow for dexterity during use. Preferably, the handle 300 is comprised of a coated braided wire for its strength and durability and includes a grip 201 positioned at a center of the length of the handle 300.

The lid 200 of the device 10 is sized and shaped for placement on the top side 101 to enclose and seal the interior cavity 104 of the device 10 during use. The lid 200 is preferably circular and includes a housing 201 for placement of the heating components 400 of the device 10. The housing 201 including a switch 202, the switch 202 turning on the device 10 and allowing power to the operating components of the device 10. The power for the device 10 is provided through communication with an electrical outlet from a cord 230 and plug 231. The cord 230 and plug 231 are retained on the lid 200 by being wrapped around the lid 200 exterior and secured with an upper lip 203 and lower lip 204, wherein the space between the upper lip 203 and lower lip 204 defines a recess to secure the cord 230 wraps. A pair of lid retaining rings 205 are positioned with each ring 205 on an opposed side of the lid 200 and aligned with the retaining rings 111 of the body portion 100. The lid retaining rings 205 secure the handle 300 to the lid 200, wherein the lid 200 cannot be removed from the handle 300. Accordingly, the lid 200, body portion, and handle 300 are all in fictional communication and aligned so as the lid 200 cannot be easily separated from the body portion 100.

An interior space of the housing 201 provides a cavity for the placement of the heating elements 400 of the device 10. The heating elements 400 of the device 10 operate by drawing heated air into the interior cavity 104. The housing 201 includes apertures 210 in communication with the interior space and allowing for the flow of air from an exterior to an interior of the housing 201. Within the housing 201 interior is the heating element 400 and a fan 401, wherein the fan 401 draws in exterior air across the heating element 400 and into the interior space 104 and circulates this heated air throughout the interior cavity 104.

A central chamber 402 is positioned at a central position of the interior cavity 104 and extends a height of the interior cavity 104 from a top side 101 of the body portion 100 to the bottom side 102, wherein the central chamber 402 is coupled to the housing 201 interior to receive and distribute heated air across the height of the interior cavity 104. This central chamber 402 includes a plurality of apertures 420 positioned at various heights of the central chamber 402 to ensure an even distribution of heated air and to allow for movement of this heated air throughout the interior cavity 104.

Caulk and sealant tubes 1 stored within the interior cavity are placed in a vertical position and positioned on a bottom rack 501 and top rack 502. The racks 501, 502 are sized and shaped to conform to the shape of the interior cavity. Preferably these racks 501, 502 are circular planar and have a central aperture for receipt around the central chamber 402. The bottom rack 501 is positioned near the bottom end 102 of the interior cavity 104 and includes a plurality of apertures 510 sized to receive the tip of a caulk or sealant tube 1. The top rack 502 is positioned a height above the bottom rack 501 and includes a plurality of apertures 520 sized to receive the diameter of a caulk or sealant tube 1. In the preferred embodiment of the present invention, the racks 501, 502 of the device 10 are configured to secure up to twelve (12) tubes 1 of caulk or sealant.

A tray 503 may be positioned adjacent to the top side 101 interior cavity 104 and designed to support additional items and materials for drying, such as gloves. The tray 503 is sized and shaped to conform to the cavity 104 and includes a central aperture for receipt around the central chamber 402, wherein heated air is distributed from the central chamber 402 and across the tray 503.

In use, a user of the device 10 will place the tubes 1 to be heated into the racks 501, 502 of the device 10 by aligning the tubes with the applicable apertures. The lid 200 is placed upon the top side 101 of the body portion 100 to enclose and secure interior 104 of the device 10. The device 10 is then powered on through the power cord 230 and plug 231 where heat is circulated into the interior cavity 104 and heats the retained tubes 1 within the device 10.

While the invention has been described above in terms of specific embodiments, it is to be understood that the invention is not limited to these disclosed embodiments. Upon reading the teachings of this disclosure many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

1. A caulk warming device, the device adapted to warm and store tubes of caulk, the device comprising:
a body portion, the body portion including an exterior sidewall defining an interior cavity and having a top side defining an opening communicating with the interior cavity, and a bottom side, the bottom side attached to the exterior sidewall and defining the bottom of the body portion;
a lid portion, the lid positioned on the top side and selectively sealing the interior cavity during use, the lid portion including a housing;
a rack portion; the rack portion sized for receipt within the interior cavity and adapted to retain a tube of caulk in a vertical position; and
a heating element, the heating element positioned within the housing and heating the interior cavity.

2. A device as in claim 1, wherein the device includes a handle.

3. A device as in claim 1, wherein the device includes a pair of racks.

4. A device as in claim 1, wherein a central chamber is positioned within the interior cavity and in communication with the heating element, the central chamber extending a height of the interior cavity and including a plurality of apertures, the apertures allowing for the distribution of heat within the interior cavity.

5. A device as in claim 1, wherein the device includes a tray positioned within the interior cavity.

6. A device as in claim 4, wherein the heating element includes a fan.

7. A device as in claim 2, wherein the handle is secured to the lid and to the body portion.

8. A caulk warming device, the device adapted to warm and store tubes of caulk, the device comprising:
a body portion, the body portion including an exterior sidewall defining an interior cavity and having a top side defining an opening communicating with the interior cavity, and a bottom side, the bottom side attached to the exterior sidewall and defining the bottom of the body portion;
a circular planar rack member adapted to fit inside the interior cavity, the circular planar rack member including a plurality of apertures, the apertures sized to receive a tube of caulk in a vertical position;
a lid portion, the lid positioned on the top side and selectively sealing the interior cavity during use, the lid portion including a housing;
a heating element, the heating element positioned within the housing and heating the interior cavity, the heating element including a fan, the fan circulating air within the interior cavity; and
a central chamber, the central chamber extending a height of the interior cavity, the central chamber in communication with the heating element and including a plurality of apertures, the plurality of apertures allowing a distribution of heated air throughout the interior cavity.

9. A device as in claim 8, wherein the device includes a handle.

10. A device as in claim 8, wherein the device includes a pair of racks.

11. A device as in claim 8, wherein the device includes a tray positioned within the interior cavity.

12. A caulk warming device, the device adapted to warm and store tubes of caulk, the device comprising:
a body portion, the body portion including an exterior sidewall defining an interior cavity, the body portion comprising:
a top side, the top side defining an opening communicating with the interior cavity;
a bottom side, the bottom side attached to the exterior sidewall and defining the bottom of the body portion; and
a pair of retaining rings, each ring of the pair of retaining rings positioned on opposed sides of the exterior sidewall;
a lid portion, the lid positioned on the top side and selectively sealing the interior cavity during use, the lid portion comprising:
a housing, the housing defining an interior portion, the interior portion in communication with the interior cavity; and
a pair of retaining rings, each ring of the pair of retaining rings positioned on an opposed side of the lid;
a heating element, the heating element positioned within the housing and heating the interior cavity, the heating element including a fan, the fan circulating air within the interior cavity;
a central chamber, the central chamber extending a height of the interior cavity, the central chamber in communication with the heating element and including a plurality of apertures, the plurality of apertures allowing a distribution of heated air throughout the interior cavity;
a circular planar rack member adapted to fit inside the interior cavity, the circular planar rack member including a plurality of apertures, the apertures sized to receive a tube of caulk in a vertical position; and
a handle, the handle retained within the retaining rings of the lid and the retaining rings of the body portion.

13. A device as in claim 12, wherein the device includes a pair of racks.

14. A device as in claim 12, wherein the device includes a tray positioned within the interior cavity.
